(19) United States
(12) Patent Application Publication
(10) Pub. No.: US 2024/0424681 A1
(43) Pub. Date: Dec. 26, 2024

(54) METHOD FOR OPERATING A COLLABORATIVE ROBOT AND COLLABORATIVE ROBOT FOR CARRYING OUT SAID METHOD

(71) Applicant: NEURA ROBOTICS GMBH, Metzingen (DE)

(72) Inventor: David REGER, Metzingen (DE)

(21) Appl. No.: 18/754,893

(22) Filed: Jun. 26, 2024

(30) Foreign Application Priority Data
Jun. 26, 2023 (DE) 102023116771.5

(51) Int. Cl. B25J 9/16

(52) U.S. Cl. CPC B25J 9/1697

(57) ABSTRACT

A method for operating a collaborative robot includes the collaborative robot monitoring a spatial region by means of a camera and wherein the collaborative robot projects information into a projection region, which is at least a partial region of the spatial region monitored by the camera, by means of a projector which has a fixed geometric relationship with the camera. A collaborative robot for carries out the method, wherein the collaborative robot has a camera for monitoring a spatial region and a projector which is designed and configured to project information into a projection region, which is at least a partial region of the spatial region monitored by the camera, wherein the camera and the projector are arranged so as to have a fixed geometric relationship with one another in or on a component.

The invention relates to collaborative robots and to the use thereof.

The use of robots has led to significant productivity improvements in many fields of manufacturing. In addition to processes that can be carried out fully automatically by robots, there are still a large number of tasks in which humans and robots must collaborate and directly physically interact with one another. To enable such interaction while minimizing the risk of human injury, collaborative robots are used that are usually equipped with sensors that shut down the robot or at least stop its movement if the risk of human injury is detected. For example, the collaborative robot can automatically shut down in the event of unexpected contact or if a person is detected in a monitored room.

Naturally, the aim is to increase the efficiency of collaboration between person and machine and, in particular, to avoid the need for such a shutdown wherever possible. A key factor in this regard is that interaction between humans and machines, but ideally also between machines and humans, is enabled, so that humans can react preemptively to upcoming actions of the collaborative robot or can initiate their own actions. However, interaction between machine and human has hitherto been only rudimentary and not very specific, for example by means of acoustic signals, which are often lost in noisy work environments or when hearing protection is mandatory and are not perceptible to deaf people or people with impaired hearing, who as a result may be unable to carry out work with known collaborative robots. The use of warning lights is also known, but these require a person's attention to be at least temporarily diverted from the actual work process to the robot and, in addition, can only provide relatively abstract information about what the robot is currently doing.

The object of the invention is therefore to provide a method for operating a collaborative robot which improves the interaction between person and machine, in particular with regard to interaction with the person that is initiated by the machine, and to provide a collaborative robot for carrying out this method.

This object is achieved by a method having the features of claim 1 and by a collaborative robot having the features of claim 10. The respective dependent claims disclose advantageous embodiments of the invention.

In the method according to the invention for operating a collaborative robot, the collaborative robot monitors a spatial region by means of a camera and projects information into a projection region, which is at least a partial region of the spatial region monitored by the camera, by means of a projector which has a fixed geometric relationship with the camera. It can be particularly advantageous to choose the smallest possible distance between the projector and the camera and to orient them in the same direction.

Due to the fixed geometric relationship between camera and projector and due to the projection region into which the projector projects its information overlapping with the monitoring region of the camera, it is possible to project context-related information at any time by means of the projector into the relevant work region, which is at least part of the region usually monitored by the camera when the collaborative robot is operating, so that a visual communication channel is opened from the robot to the human. During work processes this is therefore particularly effective because the projection also falls into the relevant work region, i.e., into the region on which the robot's human colleague can therefore focus their attention without having to check from time to time whether the robot is issuing any warning signals.

Particularly advantageously, the human colleague's attention can be focused on the particular point relevant to the work process if the camera and the projector are moved together during operation of the collaborative robot with a component which is movably arranged on the robot and on which they are fixedly arranged in order to define the fixed geometric relationship between the projector and the camera. This can be in particular the head of the robot, which preferably also has at least one tool holder, but also a robot arm, which is likewise equipped with a tool holder, a gripper or another tool. Particularly in the case of highly complex work processes or when different work steps have to be carried out on an object from different directions, it is also conceivable to arrange the camera and projector together on an arm that can be moved in order to display the relevant work region from different perspectives and to project information in different directions.

In the method, it is particularly preferred if a controller of the collaborative robot adapts operating parameters or image data for the projector on the basis of data from the camera image and/or adapts operating data or image data from the camera on the basis of information projected by the projector. The fixed spatial relationship between the camera and the projector makes this considerably easier.

For example, the collaborative robot operated in this way can be programmed to identify a “shrug” gesture of the human colleague by evaluating the camera images and, in response to this, to use the projector to project instructions as to what the human colleague should do next.

One embodiment of the method provides that the operating parameters of the projector are changed by the controller of the collaborative robot in such a way that the focus and/or the location onto which the projector projects the information are maintained even when the collaborative robot and/or a movable part of the collaborative robot on which the camera and the projector are arranged have moved and/or during this movement. For example, if, as a consequence of such a movement, projected text information falls onto an inclined surface so that letters become distorted and/or blurred, the controller of the collaborative robot can detect this problem by analyzing the camera images and remedy it by adjusting the projection optics of the projector accordingly.

According to a further advantageous embodiment of the method, the image evaluation of the images from the camera is calibrated or refined by the controller of the collaborative robot on the basis of an evaluation of images and/or structured light beams projected by the projector into the spatial region monitored by the camera. For example, in this way, the camera can be calibrated specifically when corresponding images or structured light are projected by the projector. The method can also be used to add 3D information to images taken by a 2D camera.

In a first advantageous variant of the method, the information projected by the projector includes information about an upcoming action of the collaborative robot, for example which object the collaborative robot will grasp next or the region of the workspace into which the collaborative robot will move next. This gives the human colleague of the collaborative robot an early indication of where the colleague should or should not move to avoid contact with the collaborative robot. The human colleague thus receives indications about the intention of the collaborative robot.

In a second advantageous variant of the method, the information projected by the projector includes information about a next action to be taken by a human colleague collaborating with the collaborative robot. This reduces the demands on the human colleague and provides them with more flexibility, allowing the colleague to be used, as required, as an assistant for collaborative robots performing different tasks.

In a third advantageous variant of the method, the information projected by the projector includes safety-relevant information. For example, a region into which the human colleague of the collaborative robot is not allowed to enter can project a visual warning signal into precisely this region, either continuously or specifically when the collaborative robot detects, by evaluating the camera data, that the human colleague is approaching a dangerous region. The latter is an example of a method in which the information projected by the projector depends on the result of an evaluation of the camera image.

A collaborative robot for carrying out the method according to the invention has a camera for monitoring a spatial region and a projector which is designed and configured to project information into a projection region, which is at least a partial region of the spatial region monitored by the camera. The camera and the projector have a fixed geometric relationship with one another and are arranged in or on a shared component.

The shared component can be an arm or head of the collaborative robot. In an advantageous variant, the shared component is a module which is detachably fastened to the collaborative robot. The fastening can be effected by means of screws, magnets, snap connections or similar.

Preferably, a controller of the collaborative robot is also provided, which is designed and configured to adapt operating parameters or image data for the projector on the basis of data from the camera image and/or to adapt operating data or image data from the camera on the basis of information projected by the projector in order to be able to carry out the methods described in detail above.

Particularly preferably, the camera is in the form of a 3D camera so as to be able to clearly recognize surface structures and to be able to take this information into account when operating the projector.

The invention is explained in more detail below using figures depicting exemplary embodiments. In the drawings:

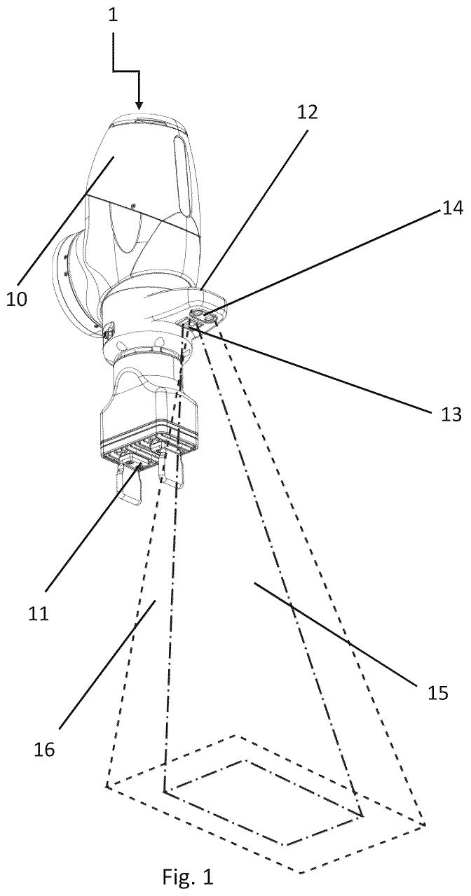

FIG. 1 shows a head of a collaborative robot according to a first embodiment of the invention;

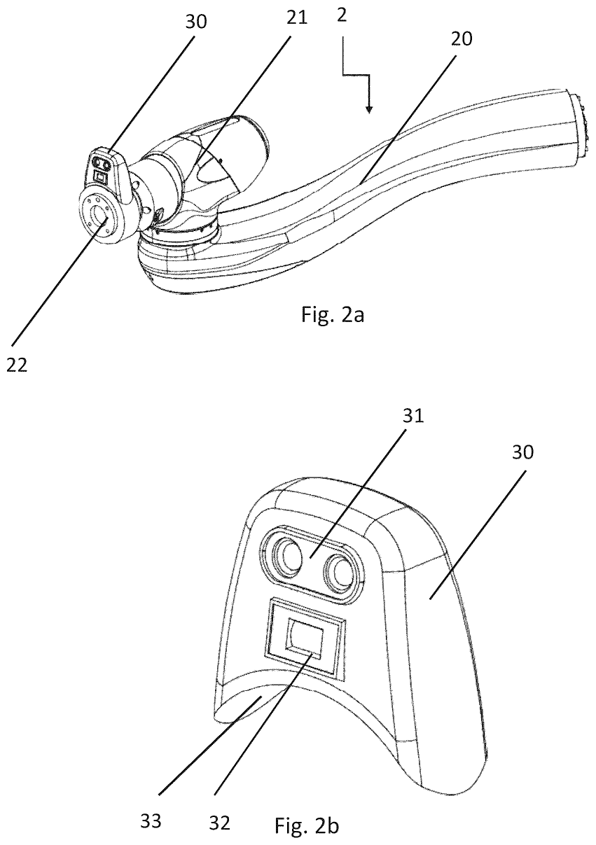

FIG. 2a shows an arm of a collaborative robot according to a second embodiment of the invention; and

FIG. 2b shows a module which is retrofitted to the collaborative robot in order to realize the invention.

FIG. 1 shows a head 10 of a collaborative robot 1, on the bottom of which a downward-facing tool mount 11 is arranged. On the bottom of a protrusion 12 which is fixedly connected to the head 10, for example arranged laterally, there are a projector 13 and a camera 14, for example a 3D camera, which, due to their installation on the protrusion 12, are arranged in a fixed geometric relationship and as close to each other as possible.

Furthermore, in FIG. 1, the projection region 15 of the projector 13, i.e., the region into which it projects information, and the spatial region 16 monitored by the camera 14 are illustrated respectively by representations of cross-sections of the actually conical regions, so as to make apparent that the projector 13 projects its information into a partial region of the spatial region 16 monitored by the camera 14.

FIG. 2a shows an arm 20 of a collaborative robot 2, on which a head 21 with a tool holder 22 is rotatably arranged. A module 30, which is shown in FIG. 2b, is detachably arranged on a shaft of the tool holder 22.

As can be seen in FIG. 2b, a camera 31, in particular designed as a 3D camera, and a projector 32 are arranged in the module 30 in a fixed geometric relationship with one another such that the projector 32 projects information into a projection region which is at least a partial region of the spatial region monitored by the camera. Due to its curved contact surface 33, the module can be detachably fastened to different locations of a collaborative robot 1, 2, and therefore the module is well suited for being retrofitted to a collaborative robot 1, 2. The collaborative robot controller can be arranged inside the module 30, and is not visible in FIG. 2b for this reason, and adapts operating parameters or image data for the projector on the basis of data from the camera image and/or adapts operating data or image data from the camera on the basis of information projected by the projector; in addition, the module 30 can also have, arranged in its interior, a separate energy supply, for example in the form of a rechargeable battery or batteries.

### LIST OF REFERENCE NUMERALS

1, 2 Collaborative robot
10 Head
11 Tool mount
12 Protrusion
13, 32 Projector
14, 31 Camera
15 Projection region
16 Spatial region
20 Arm
21 Head
22 Tool holder
30 Module
33 Contact surface

1. A method for operating a collaborative robot (1, 2), wherein the collaborative robot (1, 2) monitors a spatial region (16) by means of a camera (14, 31) and wherein the collaborative robot (1, 2) projects information into a projection region (15), which is at least a partial region of the spatial region (16) monitored by the camera (14, 31), by means of a projector (13, 32) which has a fixed geometric relationship with the camera (14, 31).

2. The method according to claim 1, characterized in that the camera (14, 31) and the projector (13, 23) are moved together during operation of the collaborative robot (1, 2) with a component which is movably arranged on the collaborative robot (1, 2) and on which the camera (14, 31) and the projector (13, 32) are fixedly arranged in order to define the fixed geometric relationship between the projector (13, 32) and the camera (14, 31).

3. The method according to claim 1, characterized in that a controller of the collaborative robot (1, 2) adapts operating parameters or image data for the projector (13, 23) on the basis of data from the camera image and/or adapts operating data or image data from the camera (14, 31) on the basis of information projected by the projector (13, 32).

4. The method according to claim 2, characterized in that the operating parameters of the projector (13, 32) are changed by the controller of the collaborative robot (1, 2) in such a way that the focus and/or the location onto which the projector (13, 32) projects the information are maintained even when the robot (1, 2) and/or a movable part of the robot (1, 2) on which the camera (14, 31) and the projector (13, 32) are arranged have moved.

5. The method according to claim 3, characterized in that the image evaluation of the images from the camera (14, 31) is calibrated or refined by the controller of the collaborative robot (1, 2) on the basis of an evaluation of images and/or structured light beams projected by the projector (13, 32) into the spatial region monitored by the camera (14, 31).

6. The method according to claim 1, characterized in that the information projected by the projector (13, 32) includes information about an upcoming action of the collaborative robot (1, 2).

7. The method according to claim 1, characterized in that the information projected by the projector (13, 32) includes information about a next action to be taken by a human colleague collaborating with the collaborative robot (1, 2).

8. The method according to claim 1, characterized in that the information projected by the projector (13, 32) includes safety-relevant information.

9. The method according to claim 1, characterized in that the information projected by the projector (13, 32) depends on the result of an evaluation of the camera image.

10. A collaborative robot (1, 2) for carrying out a method according to claim 1, wherein the collaborative robot (1, 2) has a camera (14, 31) for monitoring a spatial region (16) and a projector (13, 32) which is designed and configured to project information into a projection region (15), which is at least a partial region of the spatial region (16) monitored by the camera (14, 31), wherein the camera (14, 31) and the projector (13, 32) are arranged in a fixed geometric relationship with one another in or on a shared component.

11. The collaborative robot (1,2) according to claim 10, characterized in that the shared component is a module (30) which is detachably fastened to the collaborative robot (1, 2).

12. The collaborative robot (1,2) according to claim 10, characterized in that a controller of the collaborative robot (1, 2) is provided, which is designed and configured to adapt operating parameters or image data for the projector (13, 32) on the basis of data from the camera image and/or to adapt operating data or image data from the camera (14, 31) on the basis of information projected by the projector (13, 32).
